(19) United States
(12) Patent Application Publication
(10) Pub. No.: US 2008/0315450 A1
(43) Pub. Date: Dec. 25, 2008

(54) Composition and Method For Manufacturing a Product

(75) Inventor: Raffaella Di Girolamo, Roma (IT)

Correspondence Address: NIXON & VANDERHYE, PC, 901 NORTH GLEBE ROAD, 11TH FLOOR, ARLINGTON, VA, 22203, US

(73) Assignee: EUREKA PROJEKT Societa a responsabilita limitata per i servizi, Rijeka (HR)

(21) Appl. No.: 12/158,911

(22) PCT Filed: Dec. 12, 2006
(86) PCT No.: PCT/IB06/03557

§ 371 Date: Jul. 30, 2008

(30) Foreign Application Priority Data
Dec. 23, 2005 (IT) MO2005A000347

(51) Int. Cl. B28B 11/04; C08K 3/22; C08K 3/16; C09D 133/12

(52) U.S. Cl. 264/131; 523/123; 525/55; 525/386; 524/559; 427/430.1

(57) ABSTRACT

A composition for manufacturing a product, comprises: finely subdivided inert materials, a metal oxide, a metal chloride, a resin, a thickening agent, a surfactant; a method for manufacturing a product comprises: mixing a solution of metal chloride with a metal oxide and finely subdivided inert materials, so as to obtain a mixture; adding to said mixture a resin, an a surfactant; pouring said mixture into a mould in such a way as to impregnate a fibre material sheet positioned inside said mould; enabling said mixture to solidify, so as to manufacture said product.

### CROSS-REFERENCE TO RELATED APPLICATIONS

This application is the U.S. national phase of International Application No. PCT/IB2006/003557, filed 12 Dec. 2006, which designated the U.S. and claims priority to Italy Patent Application No. M02005A000347, filed 23 Dec. 2005, the entire contents of each of which are hereby incorporated by reference.

### DESCRIPTION

The invention relates to a composition and a method for manufacturing a product that can be made by mould forming, in particular a plant pot for domestic use or for street furniture.

Plant pots are known that are made of terracotta or of plastics.

Terracotta pots are obtained by mixing clay with water and filling proper moulds with the mixture obtained thereby. Then the formed pots are dried, extracted from the respective moulds and fired in kilns.

A drawback of the abovementioned procedure consists in the fact that the latter requires substantially complex and costly apparatuses, in particular for drying and firing the pots.

Another drawback is due to the significantly great time required for drying and firing the products.

A further drawback consists in the fact that terracotta pots, although they have a valuable aesthetic appearance, are substantially fragile products and have high specific weight. This above all means that the terracotta pots are heavy to transport, which reduces the load volume that is usable in the motor vehicles used to transport the pots to the sales outlets.

Further, the fragility of terracotta pots exposes the latter to risks of breakage, and may therefore cause accidents for the operators in charge of moving these products and/or the users of the latter.

Plastic pots are obtained by injection or rotational moulding and, unlike terracotta pots, are substantially shockproof and are provided with less specific weight.

A drawback of plastic pots consists in the fact that the corresponding manufacturing methods, i.e. injection or rotational moulding, require substantially complex and costly apparatuses.

Another drawback of plastic pots consists in the fact that the plastics tends to deteriorate over time.

A further drawback consists in the fact that the plastic pots that are no longer usable and are placed in solid urban waste constitute a component thereof that has a great environmental impact.

An object of the invention is to improve known methods for manufacturing products, in particular pots, that are manufacturable by mould forming.

Another object is to provide a method and a composition that enable pots to be manufactured in a substantially rapid manner and without using costly systems.

A further object is to provide a method and a composition that enable pots to be manufactured that are substantially shock-resistant and are provided with a not high specific weight.

Still another object is to provide a product that is manufacturable through mould forming, in particular a pot, which is resistant to shocks, is provided with a not high specific weight and is not very sensitive to aging.

In a first aspect of the invention there is provided a composition for manufacturing a product, comprising: finely subdivided inert materials, a metal oxide, a metal chloride, a resin, a thickening agent, a surfactant.

In an embodiment, the metal oxide comprises magnesium oxide.

In another embodiment, the metal chloride comprises magnesium chloride.

In a further embodiment, the composition further comprises a thickening agent.

In a second aspect of the invention there is provided a method for manufacturing a product, comprising:
mixing a solution of a metal chloride with a metal oxide and finely subdivided inert materials, so as to obtain a mixture;
adding to said mixture a resin, a thickening agent and a surfactant;
pouring said mixture into a mould in such a way as to impregnate a fibre material sheet positioned inside said mould;
enabling said mixture to solidify, so as to manufacture said product.

In an embodiment, the metal oxide comprises magnesium oxide.

In another embodiment, the metal chloride comprises magnesium chloride.

In a further embodiment, the product obtained is coated with a transparent polymer-base layer.

In a third aspect of the invention there is provided a composition for manufacturing a product, comprising: a metal sulphate, a metal oxide, a metal chloride, a resin, a surfactant, a fluidifying agent.

In a fourth aspect of the invention there is provided a method for manufacturing a product, comprising:
mixing a metal chloride, a metal oxide and a metal sulphate, so as to obtain a mixture;
adding to said mixture a resin, a fluidifying agent and a surfactant;
enabling said mixture to solidify inside a mould, so as to manufacture said product.

Owing to these aspects, compositions and methods are made available for manufacturing products, for example plant pots for domestic use or for street furniture, in a substantially rapid manner and without using complex and/or costly apparatuses.

In fact, neither the dryers and the kilns required for manufacturing terracotta pots, nor the injection or rotational moulding apparatuses used for manufacturing plastic pots are necessary.

Decorated products, for example pots, which are obtainable by the aforesaid methods and/or compositions, are substantially shock-resistant, are provided with a not high specific weight and are scarcely sensitive to aging.

The fibre material sheet acts as a strengthening element in the pots and improves the mechanical properties thereof. Further, pots obtained from the aforesaid compositions are significantly lighter than terracotta pots, although they share with the latter a pleasant aesthetic appearance.

The resin in the composition, and therefore in the mixture, makes the pots more resistant to water and less sensitive to aging, thus preventing the formation of cracks and/or the occurrence of chromatic modifications.

In a fifth aspect of the invention, there is provided a composition for coating a product, comprising a transparent polymer, an organic solvent and a plasticising agent.

In a sixth aspect of the invention, there is provided a method for coating a product, comprising:
preparing a liquid film from a transparent polymer;
adding a plasticising agent to said liquid film;
applying said liquid film to said product, in such a way as to obtain a transparent coating layer.

Owing to these aspects, it is possible to obtain a pot that is more resistant to shocks and is impermeable to water.

In particular, the transparent polymeric layer enables the presence of efflorescences on the external surface of the pot to be prevented.

Further, the transparent polymeric layer enables a shiny, “glassy” finish to be obtained, which finish gives the product a valuable aesthetic appearance that is similar to the aesthetic appearance of ceramic products but which is obtainable, unlike the latter, without using costly apparatuses and in a significantly shorter time.

A mixture that is useable for manufacturing a decorative product, such as a pot or a flower holder for domestic use, or a tub for plants for street furniture, is obtained from a composition having an average percentage formula (anhydrous) expressed in the following Table A:

TABLE A

| Component | Range % in weight |
|---|---|
| Ground inert materials | 2-60 |
| Metal oxide | 20-70 |
| Metal chloride | 5-40 |
| Resin | 1-10 |
| Surfactant | 0.1-3 |
| Thickening agent | 0.1-3 |

The ground inert materials can be obtained by grinding fragments of clay products (broken bricks) or by clay from clay pits, which clay is first fired at a temperature of 600-900° C. in a rotating kiln, which is of known type and not shown, and is subsequently ground. In both cases, grinding is conducted in such a way as to produce inert materials having granulometry comprised between 100 mμ and 1 mm. The inert materials may also comprise sand, ceramic sludge or other matter.

In an embodiment, the ground inert materials are equal to approximately 15% of the composition.

In an embodiment, the metal oxide comprises magnesium oxide (MgO).

In another embodiment, the metal oxide is equal to approximately 50% of the composition.

In a further embodiment, the metal chloride comprises magnesium chloride (Mg₂Cl₂).

In another further embodiment, the metal chloride is equal to approximately 30% of the composition.

The resin may comprise urea-formaldehyde, urea-melamine or an acrylic resin.

In an embodiment, the resin is equal to approximately 4% of the composition.

The thickening agent may comprise fish glue, rice glue or cellulose.

In an embodiment, the thickening agent is equal to approximately 0.5% of the composition.

The surfactant is of anionic type, and in an embodiment, it is equal to approximately 0.5% of the composition.

For manufacturing a product, for example a plant pot, above all flexible fibre material sheets are positioned inside a mould for pots, of known type. The mould may have a thickness comprised between 0.5 and 10 mm, and may be made of rubber latex so as to enable the formed product to be extracted more easily from the mould.

The fibres constituting the sheets may be natural or artificial, and the artificial fibres may be organic or inorganic.

In an embodiment, natural fibres of vegetable origin are provided, such as, for example: coconut fibres, jute fibres, palm fibres (vegetable horsehair), broom fibres, hemp fibres.

In another embodiment, there are provided organic artificial fibres, such as, for example: carbon fibres, polyamide fibres.

In a further embodiment, there are provided inorganic artificial fibres, such as glass fibre.

After positioning the flexible fibre material sheets, a saturated water solution of magnesium chloride (Mg₂Cl₂) is prepared, which is poured into a mixer of known type. Magnesium oxide (MgO) and ground inert materials are added, by mixing, to the saturated magnesium chloride mixture. Subsequently, and still mixing, the resin, the surfactant and the thickening agent are added so as to obtain a mixture that can be poured into the mould.

In an embodiment, adding pigments, for example oxides, is provided so as to obtain a pot coloured in a desired manner.

Once the mixture has been obtained, the latter is poured inside the mould containing the fibre material sheets, in such a way that the sheets are completely impregnated by the mixture.

In an embodiment, the mixture is applied, for example using a brush, to the fibre material sheets and the latter are then inserted into the mould.

Once a period of time of about 4 hours has elapsed, which period is necessary to enable the mixture to solidify in the mould and to thus form the pot, the latter can be extracted from the respective mould and is ready to be stored, transported, or used.

In an embodiment, the moulds containing the mixtures are placed in a dryer at 60° C., this enabling the aforesaid period of time to be reduced from 4 hours to approximately 1 hour.

Another composition, which is usable for producing a mixture that is particularly suitable for mould forming of products, has an average percentage formula (anhydrous) expressed in the following Table B:

TABLE B

| Component | Range % in weight |
|---|---|
| Metal sulphate | 45-25 |
| Metal oxide | 8-32 |
| Metal chloride | 45-25 |
| Resin | 0.98-10 |
| Surfactant | 0.07-2 |
| Fluidifying agent | 0.95-6 |

The metal sulphate comprises magnesium sulphate.

In an embodiment, the metal sulphate is equal to approximately 35% of the composition.

The metal oxide comprises magnesium oxide (MgO).

In an embodiment, the metal oxide is equal to approximately 20% of the composition.

The metal chloride comprises barium chloride.

In an embodiment, the metal chloride is equal to approximately 35% of the composition.

The resin may comprise urea-formaldehyde, urea-melamine or an acrylic resin.

In an embodiment, the resin is equal to approximately 5% of the composition.

In an embodiment, the surfactant is equal to approximately 1.5% of the composition.

The fluidifying agent may comprise an ether polycarboxylate-based product, such as, for example, “Glenium 51” (BASF).

In an embodiment, the fluidifying agent has a weight percentage equal to 1.5%.

When the composition shown in Table B is used, a solution is prepared by mixing 5 moles of magnesium sulphate (for example, magnesium sulphate heptahydrate MgSO₄. 7_{H}2O), 5 moles of barium chloride (for example, dehydrated barium chloride BaCl₂. 2H₂O) and 11 moles of water. After pouring this solution into a mixer of known type, 6 moles of magnesium oxide (MgO) are added by mixing.

The resin, the surfactant and the fluidifying agent are then added, by mixing, so as to obtain the mixture.

In an embodiment, adding pigments is provided, for example oxides, to obtain a pot that is coloured in a desired manner.

In another embodiment, after obtaining the mixture, the latter is further mixed with ground inert materials and/or sand, which are provided in a weight percentage that is not greater than 50%.

The mixture based on the composition shown in Table B does not require flexible fibre material sheets to be used as strengthening elements and therefore, once it has been obtained, it can be poured directly into proper moulds. Nevertheless, if it is desired to increase the mechanical properties of the product, it is also possible to use the fibre material sheets.

In an embodiment, the flexible fibre material sheets are positioned inside the pot mould in such a way as to be impregnated by the mixture when the latter is poured into the mould.

In another embodiment, the mixture is applied, for example by means of a brush, on the fibre material sheets, and the latter are then inserted into the mould.

The fibres constituting the sheets can be natural or artificial, and the artificial fibres may be organic or inorganic.

In an embodiment, there are provided natural fibres of vegetable origin, such as, for example: coconut fibres, jute fibres, palm fibres (vegetable horsehair), broom fibres, hemp fibres.

In another embodiment, there are provided organic artificial fibres, such as, for example: carbon fibres, polyamide fibres.

In a further embodiment, there are provided inorganic artificial fibres, such as glass fibre.

Once a suitable period of time has elapsed, for example a period equal to approximately 4 hours, in order to enable the mixture to solidify in the mould and form the pot, the latter can be extracted from the respective mould and is ready to be stored, transported or used.

In an embodiment, the moulds containing the mixtures are placed in a dryer at 60° C., thus enabling the period of time to be reduced to approximately 1 hour.

The pot obtained using the composition in Table A, or the composition in Table B, can be coated with a transparent polymeric layer, which is obtained from a further composition having an average percentage formula expressed in the following Table C:

TABLE C

| Component | Range % in weight |
|---|---|
| Transparent polymer | 5-70 |
| Organic solvent | 90-30 |
| Plasticising agent | 1-5 |

The transparent polymer comprises an acrylic polymer, for example polymethylmethacrylate.

In an embodiment, there is provided polymethylmethacrylate in a percentage comprised between 20% and 50% of the composition.

The solvent may comprise: xylene, toluene, isopropylic alcohol, dimethyl ketone, methyl ethyl ketone, methyl isobutyl ketone, butyl acetate. These solvents, used together or alternatively, enable the viscosity or solidification speed of the transparent layer to be varied. In particular, the use of the isopropylic alcohol enables the shine of the transparent layer to be accentuated.

In an embodiment, toluene is provided in a percentage comprised between 80% and 50% of the composition.

The plasticising agent comprises phthalates, which make the transparent layer less stiff and therefore less fragile.

In order to obtain the transparent polymeric layer, the solid polymethylmethacrylate, for example in beads, is dissolved in an organic solvent, for example toluene. A liquid film is thus obtained to which the plasticising agent is added.

Pigments can also be added, for example oxides, if it is wished to produce a chromatic effect in the transparent layer.

The liquid film is then applied to the surface of the product, for example a pot or a flower holder, and can be applied manually (by brush), by spray gun, by an curtain-coating machine of known type, or by immersion.

By drying, the liquid film forms a transparent layer that gives a significantly pleasant aesthetic appearance to the product, further making the latter impermeable to water and more resistant to shocks owing to the presence of the plasticising agent.

It should further be noted that the aforesaid liquid film can be effectively used also for coating products, such as pots for flowers and plants, obtained by means of compositions and/or methods other than those disclosed above.

1. Composition for manufacturing a product, comprising: finely subdivided inert materials, a metal oxide, a metal chloride, a resin, a thickening agent, a surfactant.

2. Composition according to claim 1, wherein said metal oxide comprises magnesium oxide.

3. Composition according to claim 1, wherein said metal chloride comprises magnesium chloride.

4. Composition according to claim 1, having an average percentage formula comprising:

| | |
|---|---|
| Finely subdivided inert materials | 2-60% |
| Metal oxide | 20-70% |
| Metal chloride | 5-40% |
| Resin | 1-10% |
| Surfactant | 0.1-3% |
| Thickening agent | 0.1-3% |

5. Composition according to claim 4, wherein said finely subdivided inert materials have a percentage value equal to approximately 15.

6. Composition according to claim 4, wherein said metal oxide has a percentage value equal to approximately 50.

7. Composition according to claim 4, wherein said metal chloride has a percentage value equal to approximately 30.

8. Composition according to claim 4, wherein said resin has a percentage value equal to approximately 4.

9. Composition according to claim 4, wherein said surfactant has a percentage value equal to approximately 0.5.

10. Composition according to claim 4, wherein said thickening agent has a percentage value equal to approximately 0.5.

11. Composition according to claim 1, wherein said inert materials are selected from a group comprising: ground fired clay, sand, ceramic sludge.

12. Composition according to claim 11, wherein said ground fired clay has a granulometry comprised between 100 mμ and 1 mm.

13. Composition according to claim 1, wherein said resin is selected from a group comprising: urea-formaldehyde, urea-melamine, acrylic resin.

14. Composition according to claim 1, wherein said surfactant is an anionic surfactant.

15. Composition according to claim 1, wherein said thickening agent is selected from a group comprising: fish glue, rice glue, cellulose.

16. Composition according to claim 1, further comprising pigments.

17. Composition according to claim 16, wherein said pigments comprise oxides.

18. Product comprising a composition according to claim 1.

19. Product according to claim 19, comprising a container for flowers and/or plants.

20. Method for manufacturing a product, comprising:
mixing a solution of a metal chloride with a metal oxide and finely subdivided inert materials, so as to obtain a mixture;
adding to said mixture a resin, a thickening agent and a surfactant;
pouring said mixture into a mould so as to impregnate a fibre material sheet positioned inside said mould;
enabling said mixture to solidify, so as to manufacture said product.

21. Method according to claim 20, further comprising impregnating said fibre material sheet with said mixture before positioning said sheet inside said mould.

22. Method according to claim 20, wherein said metal oxide comprises magnesium oxide.

23. Method according to claim 20, wherein said metal chloride comprises magnesium chloride.

24. Method according to claim 20, comprising preparing said solution by dissolving said metal chloride in water.

25. Method according to claim 24, wherein said preparing comprises obtaining said solution in saturated form.

26. Method according to claim 20, wherein said adding a resin comprises selecting said resin from a group comprising: urea-formaldehyde, urea-melamine, acrylic resin.

27. Method according to claim 20, wherein said adding a thickening agent comprises selecting said thickening agent from a group comprising: fish glue, rice glue, cellulose.

28. Method according to claim 20, wherein said adding a surfactant comprises using an anionic surfactant.

29. Method according to claim 20, comprising selecting said inert materials from a group comprising: ground fired clay, sand, ceramic sludge.

30. Method according to claim 29, wherein said ground fired clay has granulometry comprised between 100 mμ and 1 mm.

31. Method according to claim 20, wherein said fibre material sheet comprises natural fibres.

32. Method according to claim 31, comprising selecting said natural fibres from a group comprising: coconut fibres, jute fibres, palm fibres, broom fibres, hemp fibres.

33. Method according to claim 20, wherein said fibre material sheet comprises organic artificial fibres.

34. Method according to claim 33, comprising selecting said organic artificial fibres from a group comprising: carbon fibres, polyamide fibres.

35. Method according to claim 20, wherein said fibre material sheet comprises inorganic artificial fibres.

36. Method according to claim 35, wherein said inorganic artificial fibres comprise glass fibre.

37. Method according to claim 20, comprising removing said product from said mould after said solidifying.

38. Method according to claim 37, comprising enabling a period of time of approximately 4 hours to elapse before said removing.

39. Method according to claim 37, comprising heat-treating said product contained in said mould before said removing.

40. Method according to claim 39, wherein said heat treating comprises maintaining said product at a temperature of approximately 60° C. for approximately 1 hour.

41. Method according to claim 20, wherein said finely subdivided inert materials are provided in a weight percentage comprised between 2% and 60%.

42. Method according to claim 20, wherein said finely subdivided inert materials are provided in a weight percentage approximately equal to 15%.

43. Method according to claim 20, wherein said metal oxide is provided in a weight percentage comprised between 20% and 70%.

44. Method according to claim 20, wherein said metal oxide is provided in a weight percentage approximately equal to 50%.

45. Method according to claim 20, wherein said metal chloride is provided in a weight percentage comprised between 5% and 40%.

46. Method according to claim 20, wherein said metal chloride is provided in a weight percentage approximately equal to 30%.

47. Method according to claim 20, wherein said resin is provided in a weight percentage comprised between 1% and 10%.

48. Method according to claim 20, wherein said resin is provided in a weight percentage approximately equal to 4%.

49. Method according to claim 20, wherein said surfactant is provided in a weight percentage comprised between 0.1% and 3%.

50. Method according to claim 20, wherein said surfactant is provided in a weight percentage equal to approximately 0.5%.

51. Method according to claim 20, wherein said thickening agent is provided in a weight percentage comprised between 0.1% and 3%.

52. Method according to claim 20, wherein said thickening agent is provided in a weight percentage equal to approximately 0.5%.

53. Method according to claim 20, further comprising adding pigments to said mixture.

54. Method according to claim 53, wherein said pigments comprise oxides.

55. Method according to claim 20, further comprising coating said product with a transparent layer.

56. Method according to claim 55, wherein said coating comprises preparing a liquid film by means of a transparent polymer.

57. Method according to claim 55, wherein said transparent polymer comprises polymethylmethacrylate.

58. Method according to claim 56, wherein said preparing comprises dissolving said transparent polymer in an organic solvent.

59. Method according to claim 58, wherein said dissolving comprises selecting said organic solvent from a group comprising: xylene, toluene, isopropylic alcohol, dimethyl ketone, methyl ethyl ketone, methyl isobutyl ketone, butyl acetate.

60. Method according to claim 56, further comprising adding a plasticising agent to said liquid film.

61. Method according to claim 60, wherein said plasticising agent comprises a phthalate.

62. Method according to claim 56, further comprising adding a pigment to said liquid film.

63. Method according to claim 56, wherein said transparent polymer is provided in a weight percentage comprised between 5% and 70%.

64. Method according to claim 56, wherein said polymethylmethacrylate is provided in a weight percentage comprised between 20% and 50%.

65. Method according to claim 58, wherein said organic solvent is provided in a weight percentage comprised between 90% and 30%.

66. Method according to claim 59, wherein said toluene is provided in a weight percentage comprised between 80% and 50%.

67. Method according to claim 60, wherein said plasticising agent is provided in a weight percentage comprised between 1% and 5%.

68. Method according to claim 56, comprising applying said liquid film to said product.

69. Method according to claim 68, wherein said applying comprises using an applying device selected from a group comprising: brush, spray dispenser, curtain-coating machine.

70. Method according to claim 68, wherein said applying comprises immersing said product in said liquid film.

71. Method according to claim 20, wherein said product comprises a container for flowers and/or plants.

72. Composition for manufacturing a product, comprising: a metal sulphate, a metal oxide, a metal chloride, a resin, a surfactant, a fluidifying agent.

73. Composition according to claim 72, wherein said metal sulphate comprises magnesium sulphate.

74. Composition according to claim 72, wherein said metal chloride comprises barium chloride.

75. Composition according to claim 72, wherein said metal oxide comprises magnesium oxide.

76. Composition according to claim 72, having an average percentage formula comprising:

| | |
|---|---|
| Metal sulphate | 45-25% |
| Metal oxide | 8-32% |
| Metal chloride | 45-25% |
| Resin | 0.98-10% |
| Surfactant | 0.07-2% |
| Fluidifying agent | 0.95-6% |

77. Composition according to claim 76, wherein said metal oxide has a percentage value equal to approximately 20.

78. Composition according to claim 76, wherein said metal sulphate has a percentage value equal to approximately 35.

79. Composition according to claim 76, wherein said metal chloride has a percentage value equal to approximately 35.

80. Composition according to claim 76, wherein said resin has a percentage value equal to approximately 5.

81. Composition according to claim 76, wherein said surfactant has a percentage value equal to approximately 1.5.

82. Composition according to claim 76, wherein said fluidifying agent has a percentage value equal to approximately 1.5.

83. Composition according to claim 72, wherein said resin is selected from a group comprising: urea-formaldehyde, urea-melamine, acrylic resin.

84. Composition according to claim 72, wherein said fluidifying agent comprises ether polycarboxylates.

85. Composition according to claim 72, further comprising pigments.

86. Composition according to claim 85, wherein said pigments comprise oxides.

87. Product comprising a composition according to claim 72.

88. Product according to claim 87, comprising a container for flowers and/or plants.

89. Method for manufacturing a product, comprising:
mixing a metal chloride, a metal oxide and a metal sulphate, so as to obtain a mixture;
adding to said mixture a resin, a fluidifying agent and a surfactant;
enabling said mixture to solidify inside a mould, so as to manufacture said product.

90. Method according to claim 89, wherein said metal sulphate comprises magnesium sulphate.

91. Method according to claim 89, wherein said metal chloride comprises barium chloride.

92. Method according to claim 89, wherein said metal oxide comprises magnesium oxide.

93. Method according to claim 89, wherein said mixing comprises preparing a solution containing said metal chloride and said metal sulphate.

94. Method according to claim 93, wherein said mixing comprises further mixing said solution with said metal oxide.

95. Method according to claim 93, wherein said preparing a solution comprises mixing 5 moles of said metal sulphate with 5 moles of said metal chloride and 11 moles of water.

96. Method according to claim 94, comprising using a quantity of metal oxide equal to 6 moles during said further mixing.

97. Method according to claim 89, wherein said adding a resin comprises selecting said resin from a group comprising: urea-formaldehyde, urea-melamine, acrylic resin.

98. Method according to claim 89, wherein said adding a fluidifying agent comprises using ether polycarboxylates.

99. Method according to claim 89, comprising pouring into said mould said mixture, after said adding.

100. Method according to claim 99, comprising positioning a fibre material sheet inside said mould, before said pouring.

101. Method according to claim 89, comprising applying said mixture to a fibre material sheet and, after said applying, positioning said fibre material sheet inside said mould.

102. Method according to claim 100, wherein said fibre material sheet comprises natural fibres.

103. Method according to claim 102, comprising selecting said natural fibres from a group comprising: coconut fibres, jute fibres, palm fibres, broom fibres, hemp fibres.

104. Method according to claim 100, wherein said fibre material sheet comprises organic artificial fibres.

105. Method according to claim 104, comprising selecting said organic artificial fibres from a group comprising: carbon fibres, polyamide fibres.

106. Method according to claim 100, wherein said fibre material sheet comprises inorganic artificial fibres.

107. Method according to claim 106, wherein said inorganic artificial fibres comprise glass fibre.

108. Method according to claim 89, comprising removing said product from said mould after said solidifying.

109. Method according to claim 108, comprising enabling a period of time of approximately 4 hours to elapse before said removing.

110. Method according to claim 108, comprising heat-treating said product contained in said mould before said removing.

111. Method according to claim 110, wherein said heat-treating comprises maintaining said product at a temperature of approximately 60° C. for approximately 1 hour.

112. Method according to claim 89, wherein said metal sulphate is provided in a weight percentage comprised between 25% and 45%.

113. Method according to claim 112, wherein said metal sulphate is provided in a weight percentage approximately equal to 35%.

114. Method according to claim 89, wherein said metal oxide is provided in a weight percentage comprised between 8% and 32%.

115. Method according to claim 114, wherein said metal oxide is provided in a weight percentage approximately equal to 20%.

116. Method according to claim 89, wherein said metal chloride is provided in a weight percentage comprised between 25% and 45%.

117. Method according to claim 116, wherein said metal chloride is provided in a weight percentage approximately equal to 35%.

118. Method according to claim 89, wherein said resin is provided in a weight percentage comprised between 0.98% and 10%.

119. Method according to claim 118, wherein said resin is provided in a weight percentage approximately equal to 5%.

120. Method according to claim 89, wherein said surfactant is provided in a weight percentage comprised between 0.07% and 2%.

121. Method according to claim 120, wherein said surfactant is provided in a weight percentage equal to approximately 1.5%.

122. Method according to claim 89, wherein said fluidising agent is provided in a weight percentage comprised between 0.95% and 6%.

123. Method according to claim 122, wherein said fluidifying agent is provided in a weight percentage equal to approximately 1.5%.

124. Method according to claim 89, further comprising mixing said mixture with pigments.

125. Method according to claim 124, wherein said pigments comprise oxides.

126. Method according to claim 89, comprising further mixing said mixture with inert materials, after said adding.

127. Method according to claim 126, wherein, during said further mixing, said inert materials are provided in a weight percentage less or the same as 50%.

128. Method according to claim 89, further comprising coating said product with a transparent layer.

129. Method according to claim 128, wherein said coating comprises preparing a liquid film by means of a transparent polymer.

130. Method according to claim 128, wherein said transparent polymer comprises polymethylmethacrylate.

131. Method according to claim 129, wherein said preparing comprises dissolving said transparent polymer in an organic solvent.

132. Method according to claim 131, comprising selecting said organic solvent from a group comprising: xylene, toluene, isopropylic alcohol, dimethyl ketone, methyl ethyl ketone, methyl isobutyl ketone, butyl acetate.

133. Method according to claim 128, further comprising adding a plasticising agent to said liquid film.

134. Method according to claim 133, wherein said plasticising agent comprises a phthalate.

135. Method according to claim 128, further comprising adding a pigment to said liquid film.

136. Method according to claim 128, wherein said transparent polymer is provided in a weight percentage comprised between 5% and 70%.

137. Method according to claim 130, wherein said polymethylmethacrylate is provided in a weight percentage comprised between 20% and 50%.

138. Method according to claim 129, wherein said organic solvent is provided in a weight percentage comprised between 30% and 90%.

139. Method according to claim 132, wherein said toluene is provided in a weight percentage comprised between 80% and 50%.

140. Method according to claim 133, wherein said plasticising agent is provided in a weight percentage comprised between 1% and 5%.

141. Method according to claim 128, comprising applying said liquid film to said product.

142. Method according to claim 141, wherein said applying comprises using an applying device selected from a group comprising: brush, spray dispenser, curtain-coating machine.

143. Method according to claim 141, wherein said applying comprises immersing said product in said liquid film.

144. Method according to claim 89, wherein said product comprises a container for flowers and/or plants.
